(19) United States
(12) Patent Application Publication
(10) Pub. No.: US 2020/0274977 A1
(43) Pub. Date: Aug. 27, 2020

(54) INFORMATION PROCESSING APPARATUS, SYSTEM AND METHOD FOR DATA TRANSFER

(71) Applicant: KAZUYA TANI, KANAGAWA (JP)

(72) Inventor: KAZUYA TANI, KANAGAWA (JP)

(73) Assignee: Ricoh Company, Ltd., Tokyo (JP)

(21) Appl. No.: 16/795,866

(22) Filed: Feb. 20, 2020

(30) Foreign Application Priority Data
Feb. 22, 2019 (JP) 2019-030443

(51) Int. Cl. H04N 1/00; G06F 3/12; H04N 1/32; H04N 1/44

(52) U.S. Cl. CPC H04N 1/00214; G06F 3/1222; H04N 1/4413; H04N 1/32096; G06F 3/1238

(57) ABSTRACT

An information processing apparatus for importing data exported from other information processing apparatus, includes circuitry; and one or more memories including a first storage area and a second storage area. The circuitry acquires a first data including one or more user registration items each having information registered in relation to a user and being assigned with identification information, acquires a second data after acquiring the first data, the second data including an access authority that is set for each of one or more user registration items, stores the first data in the first storage area, and based on a determination that an access authority for the second data is associated with the identification information of the user registration item, sets an access authority for the second data using the first data stored in the first storage area for each user registration item, and store the second data that is set in the second storage area.

### CROSS-REFERENCE TO RELATED APPLICATIONS

This patent application is based on and claims priority pursuant to 35 U.S.C. § 119(a) to Japanese Patent Application No. 2019-030443, filed on Feb. 22, 2019, in the Japan Patent Office, the entire disclosure of which is hereby incorporated by reference herein.

### BACKGROUND

### Technical Field

The present invention relates to an information processing apparatus, a system and a method for transferring data, and a recording medium.

### Description of the Related Art

There is a case in which user authentication is performed when an information processing apparatus such as an image processing apparatus is used in order to authenticate whether the user is authorized for using the information processing apparatus. Furthermore, there is a case of utilizing a function of transmitting image data obtained by scanning a document by use of an image processing apparatus to a given address via an e-mail, etc. In the above cases, an authentication password of a user or address data such as a delivery destination address is stored in an address book of the image processing apparatus as address book data.

For example, in a case where an old image processing apparatus is updated to a new image processing apparatus, this address book data may be transferred from the old (transfer-source) image processing apparatus to the new (transfer-destination) image processing apparatus.

However, with conventional technologies, it is difficult to transfer data to which access right information is added.

### SUMMARY

Example embodiments include an information processing apparatus for importing data exported from other information processing apparatus, the information processing apparatus including circuitry; and one or more memories including a first storage area and a second storage area. The circuitry acquires a first data including one or more user registration items each having information registered in relation to a user and being assigned with identification information, acquires a second data after acquiring the first data, the second data including an access authority that is set for each of one or more user registration items, stores the first data in the first storage area, and based on a determination that an access authority for the second data is associated with the identification information of the user registration item, sets an access authority for the second data using the first data stored in the first storage area for each user registration item, and store the second data that is set in the second storage area.

### BRIEF DESCRIPTION OF THE SEVERAL VIEWS OF THE DRAWINGS

A more complete appreciation of the disclosure and many of the attendant advantages and features thereof can be readily obtained and understood from the following detailed description with reference to the accompanying drawings, wherein:

FIG. 1 is a diagram illustrating access right information set when a document is accumulated;

FIG. 2A is an illustration for explaining inconvenience that occurs when document data including address book data and access right information is transferred;

FIG. 2B is an illustration for explaining inconvenience that occurs when document data including address book data and access right information is transferred;

FIG. 3 is an example of a schematic configuration diagram of a data transfer system;

FIG. 4 is an example of a hardware configuration diagram of an image processing apparatus;

FIG. 5 is an example of a hardware configuration diagram of a PC or the cloud;

FIG. 6 is an example of a function block diagram illustrating functions of a transfer-source image processing apparatus and a transfer-destination image processing apparatus in blocks;

FIG. 7 is an example of a diagram schematically illustrating information included in address book data;

FIG. 8A is an example of a diagram schematically illustrating information included in document data;

FIG. 8B is an example of a diagram schematically illustrating access right information;

FIG. 9A is an example of a flowchart for explaining the processing for accumulating document data;

FIG. 9B is an example of a flowchart for explaining the processing for utilizing document data;

FIG. 10 is a diagram illustrating an example of correspondence between entry IDs in access right information and entry IDs in address book data;

FIG. 11A is a diagram illustrating an example of a transferred data selection screen;

FIG. 11B is a diagram illustrating an example of a function selection screen;

FIG. 12A is a diagram illustrating an example of an export executing screen;

FIG. 12B is a diagram illustrating an example of an export completion screen;

FIG. 13 is an example of a sequence diagram illustrating a procedure in which a transfer-source image processing apparatus exports address book data to a PC and a transfer-destination image processing apparatus imports the address book data from the PC;

FIG. 14 is an example of a sequence diagram illustrating a procedure in which a transfer-source image processing apparatus exports document data to a PC and a transfer-destination image processing apparatus imports document data from the PC;

FIG. 15 is an example of a flowchart illustrating a procedure in which a transfer-source image processing apparatus exports document data;

FIG. 16 is a diagram illustrating an example of transfer data;

FIG. 17 is an example of a flowchart illustrating a procedure in which a transfer-destination image processing apparatus imports document data;

FIG. 18 is an example of a flowchart for explaining details of processing of accumulating access right information;

FIG. 19 is an example of a function block diagram illustrating functions of a transfer-source image processing apparatus and a transfer-destination image processing apparatus in blocks;

FIG. 20 is an example of a diagram for explaining generation of transfer access right information;

FIG. 21 is an example of a flowchart illustrating a procedure in which a transfer-source image processing apparatus exports document data;

FIG. 22 is an example of a flowchart illustrating a procedure in which a transfer-destination image processing apparatus imports document data;

FIG. 23 is an example of a diagram schematically illustrating direct transfer from a transfer-source image processing apparatus to a transfer-destination image processing apparatus; and

FIG. 24 is an example of a sequence diagram illustrating a procedure in which a PC requests a transfer-source image processing apparatus to export address book data and the PC requests a transfer-destination image processing apparatus to import address book data.

The accompanying drawings are intended to depict embodiments of the present invention and should not be interpreted to limit the scope thereof. The accompanying drawings are not to be considered as drawn to scale unless explicitly noted.

### DETAILED DESCRIPTION

The terminology used herein is for the purpose of describing particular embodiments only and is not intended to be limiting of the present invention. As used herein, the singular forms “a”, “an” and “the” are intended to include the plural forms as well, unless the context clearly indicates otherwise.

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Hereinafter, as examples of a mode for carrying out the present invention, a data transfer system and a data transfer method by use of the data transfer system are described with reference to the drawings.

In a case where an image processing apparatus is updated, there is a demand to transfer document data accumulated in the image processing apparatus. For example, there is a printing form (referred to as pull printing, etc.) in which a user accumulates document data in an image processing apparatus and operates the image processing apparatus to print the document data. If the document data is transferred to another image processing apparatus via an extraneous storage apparatus, such as a personal computer (PC) or the cloud, it is possible to reuse the document data.

On the other hand, since only authorized users should be permitted to perform printing, editing, deleting, or the like, of stored document data, there has been access control for document data, conventionally. For example, when document data is accumulated, access right information is added for each document data. In access right information, availability (access authority) of printing, editing, deleting, or the like, is set for each user in address book data. In a case of accessing document data, access control is performed based on the access authority of the user who has logged in to the image processing apparatus.

However, if the address book data and document data are transferred separately, the association between the address book data and the document data is lost, and the access control performed by the transfer-source image processing apparatus cannot be reproduced in the transfer-destination image processing apparatus.

In view of the above, in the following embodiments, an explanation is given of an information processing apparatus that is capable of transferring data to which access right information is added.

### First Embodiment

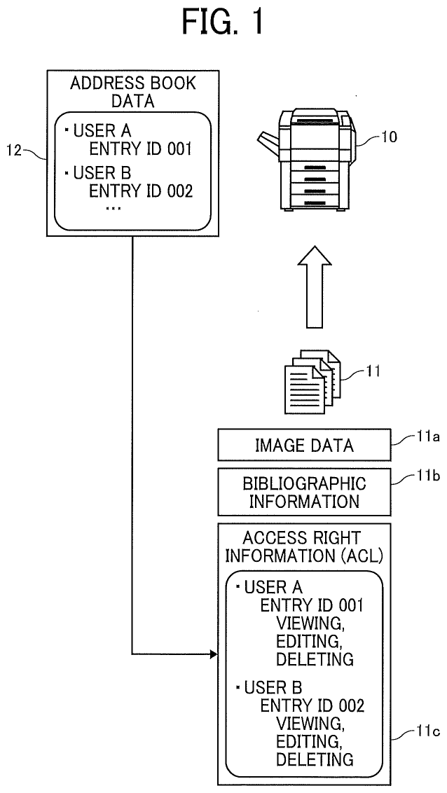

First, a supplementary explanation is given of the background related to transfer of address book data with reference to FIG. 1. FIG. 1 is a diagram for explaining the access right information 11c that is set when a document is accumulated. First, the image processing apparatus 10 preliminarily holds the address book data 12. In the address book data 12, an authentication password of each user, a delivery destination address of a document, or the like, is saved in association with an entry ID that identifies a user.

The document data 11 includes the image data 11a and the bibliographic information 11b. In a case where a user accumulates document data 11, the access right information 11c (ACL: Access Control List) is added to the document data 11 as well.

Since access right information 11c is generated for each document data 11, what kind of access right (viewing, editing, deleting, etc.) each user has is set for document data 11. For example, there may be a setting with such a rule in which a user who registered document data in an image processing apparatus 10 (such a user may be referred to as an owner) is authorized for viewing, editing, and deleting, whereas other users are authorized for viewing only. Furthermore, for access right information 11c, an entry ID in address book data 12 is set for each user.

In the above way, the access right information 11c and the address book data 12 are associated with each other at the timing when the document data 11 is accumulated, and the access control against users for the document data 11 is performed based on the access right information 11c.

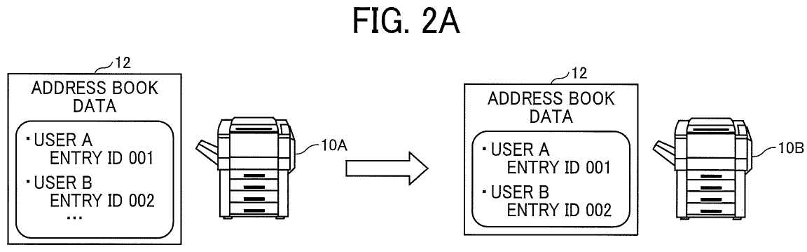

FIGS. 2A and 2B are diagrams for explaining inconvenience that occurs in a case of transferring document data 11 including address book data 12 and access right information 11c. In the following description, the reference sign of an image processing apparatus 10 that is a transfer source is 10A, and the reference sign of an image processing apparatus 10 that is a transfer destination is 10B. Further, the reference sign of a given image processing apparatus is 10.

As illustrated in FIG. 2A, although the address book data 12 is transferred from the transfer-source image processing apparatus 10A to the transfer-destination image processing apparatus 10B, an authentication password of a user and a delivery destination address of a document that are associated with an entry ID are transferred while the entry ID is the same. Therefore, conventionally, access right information 11c was not usually transferred in a case of transferring document data 11. This is because, in a case of transferring document data 11, processing of accumulating new document data 11 is performed, and an entry ID is newly set as well. For this reason, conventionally, a computer engineer (CE) has performed a process of manually adding the access right information 11c of the document data 11 of the transfer source to the document data 11 of the transfer-destination image processing apparatus 10B for each document.

Here, suppose that access right information 11c is transferred as well when document data 11 is transferred. First, when document data 11 is transferred, processing for newly accumulating the document data 11 in the transfer-destination image processing apparatus 10B occurs. Thus, an entry ID in the address book data 12 included in the image processing apparatus 10 is set as the entry ID for the access right information 11c.

Entry IDs in address book data 12 are sequential numbers given in order of registration, which may be changed because, for example, there may be a missing number due to deletion. That is, assuming that there are two image processing apparatuses 10, the same entry ID is not necessarily assigned to the same user. However, entry IDs do not change in the processing of transferring address book data 12 (made not to be changed in transfer).

For example, in a case where address book data 12 in a transfer source has not been transferred to a transfer-destination image processing apparatus 10B, there may be a case in which address book data 12 does not exist in the first place. In such a case, an entry ID cannot be set for document data 11. Furthermore, in a case where there is another address book data 12 remaining in the transfer-destination image processing apparatus 10B (for example, address book data 12 registered as a test), an entry ID in this address book data 12 is set for document data 11. However, although the same entry ID exists in the address book data 12 at the transfer source, the entry ID does not necessarily represent the same user.

As illustrated in FIG. 2B, suppose that there is another address book data 12 remaining in the transfer-destination image processing apparatus 10B and, according to this address book data 12, the entry ID of USER A is 011 and the entry ID of USER B is 012. In a case where the entry IDs are set for the access right information 11c, based on this address book data 12, the entry ID of USER A is changed from 001 to 011 and the entry ID of USER B is changed from 002 to 012.

As described above, there has been a case in which an association between address book data and document data is lost, and access control in a transfer-source image processing apparatus 10A cannot be reproduced in a transfer-destination image processing apparatus 10B.

If address book data 12 is subsequently transferred from the transfer-source image processing apparatus 10A, the entry ID of USER A in the address book data 12 becomes 001 and the entry ID of USER B becomes 002. Thus, for example, there may be a situation in which, in a case where the entry ID of a logged-in user is 001, the access rights (viewing, editing, deleting, etc.) corresponding to ENTRY ID 001 in the access right information 11c does not represent the access rights of the logged-in user. Therefore, like the mentioned case, there has been a case in which an association between address book data and document data is lost, and access control in a transfer-source image processing apparatus cannot be reproduced in a transfer-destination image processing apparatus.

<Outline of Transfer of Address Book Data and Document Data>

Therefore, in the present embodiment, address book data 12 and document data 11 are transferred in the following manner.

A. In a case where a CE transfers (more precisely, imports) address book data 12 and document data 11, the address book data 12 is transferred first, and then the document data 11 is transferred. There, in a case where address book data or document data exists in the transfer destination of the data, the transfer-destination image processing apparatus 10B deletes or formats (initializes) the data stored in an address book data storage or document data storage (i.e., a memory storing such data) of the transfer destination of the data.

B. When the document data 11 is imported, the transfer-destination image processing apparatus 10B determines whether the entry ID of the access right information 11c exists as an entry ID in the address book data 12. That is, whether the entry ID of the access right information 11c matches the entry ID in the address book data 12 is determined for each entry ID. In a case where the entry IDs match, the access authority associated with the entry ID in the access right information 11c is imported. In other words, the access right information 11c in the document data 11 is set using the address book data 12 that has already been transferred.

As described above, by transferring the address book data 12 first, the entry ID of the address book data 12 in the transfer source can be set for the document data 11. Furthermore, by determining whether the entry ID in the access right information 11c exists in the address book data 12, it is possible to transfer the address book data 12 and the document data 11 to the transfer-destination image processing apparatus 10B with the association between the address book and the document data 11 in the transfer-source image processing apparatus 10A maintained. Therefore, it is possible to transfer the address book data 12 and the access right for the document data 11, so that the access control in the transfer-source image processing apparatus 10A can be reproduced in the transfer-destination image processing apparatus 10B.

A user registration item is an item for which information related to a user is registered. Information related to a user is, for example, access right information, address book data, or the like. In the present embodiment, the information related to a user is referred to as the term “entry”. An entry means being registered or a registered item, etc. An entry ID is identification information of a user registration item (identification information of an entry).

An extraneous storage apparatus is a storage apparatus that is not internal to an information processing apparatus. The extraneous storage apparatus may have any name as long as the extraneous storage apparatus has a storage function. In the present embodiment, the extraneous storage apparatus corresponds to a personal computer (PC) or the cloud. A storage apparatus may be referred to as a storage.

To maintain an association with identification information of an entry means that, regarding a user who is indicated by an entry in a transfer-source image processing apparatus 10A and another entry in a transfer-destination image processing apparatus 10B, it is possible to specify the same user by tracing the said another entry. The entry ID before transfer need not match with the entry ID after transfer.

The information processing apparatus (image processing apparatus 10 in the following description) of the present embodiment may be any apparatus that processes data to which an access right is added.

<System Configuration Example>

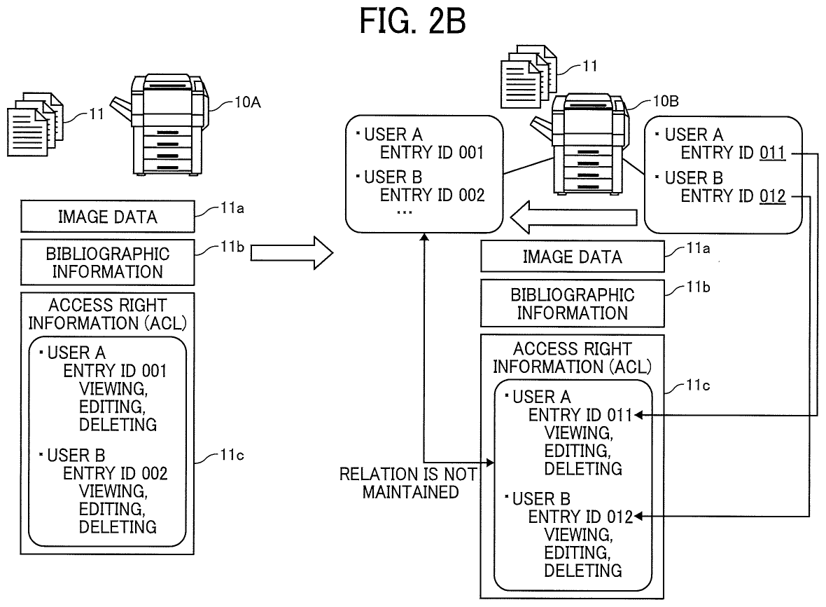

Next, with reference to FIG. 3, description is given of an example of system configuration. FIG. 3 is an example schematic configuration diagram of the data transfer system 100. The data transfer system 100 illustrated in the drawing includes the transfer-source image processing apparatus 10A, the transfer-destination image processing apparatus 10B, the PC 40, and the cloud 50. FIG. 3 illustrates the flow of transfer, and, thus, the transfer-source image processing apparatus 10A and the transfer-destination image processing apparatus 10B are not necessarily connected via the PC 40 or the cloud 50. For an update process of an image processing apparatus 10 in general, a CE visits a customer and operates the transfer-source image processing apparatus 10A to export address book data 12 and document data 11 to the PC 40 or the cloud 50. Then, the transfer-source image processing apparatus 10A is carried out and the transfer-destination image processing apparatus 10B is carried in. Thereafter, the CE operates the transfer-destination image processing apparatus 10B to import the address book data 12 and the document data 11 from the PC 40 or the cloud 50. Accordingly, there may be a case in which the transfer-source image processing apparatus 10A and the transfer-destination image processing apparatus 10B are not present together.

Note that export is to output data to an extraneous source, and import is to install data. Export and import are the two phases included in transfer. Export and import may include processes other than inputting and outputting data. That is, export and import do not simply mean data communication but include converting data into a such a form that is appropriate for the transfer-destination image processing apparatus 10B to be dealt with as in the transfer-source image processing apparatus 10A.

As illustrated in FIG. 3, in a case where address book data 12 is transferred to update data in an image processing apparatus 10, a setting value 13 (setting values 13) is transferred as well. Setting values 13 are values of various setting items related to the image processing apparatus 10. For example, there are a variety of setting values 13 such as energy saving setting (duration until automatically turning to a sleep mode, etc.), whether user authentication is performed or not, whether a button related to a function (which is implemented by an installed application) is displayed or not in a case where the function does not exist, the initial values of setting for printing, scanning, copying, etc., and an IP address of a server for monitoring, etc. It is not necessary that the setting value 13 is associated with address book data 12 or document data 11. Although the setting value 13 is transferred together with the address book data 12 in the present embodiment, the setting value 13 may be transferred independently.

In the present embodiment, at least the transfer-source image processing apparatus 10A and the transfer-destination image processing apparatus 10B are capable of communicating with the PC 40 or the cloud 50 via a network.

The network may be a network in general, such as a local area network (LAN) or the Internet. A LAN may be used for communication with the PC 40. The Internet may also be used for communication with the cloud 50. For security of address book data 12, it is desirable to use a dedicated line such as wide area Ethernet (registered trademark) or a virtual private network (VPN) in a case of using the cloud 50. It is also possible that communication for a part or all of the network can be performed wirelessly by use of wireless fidelity (Wi-Fi), 3G, 4G, long term evolution (LTE), 5G, Bluetooth (registered trademark), etc.

An image processing apparatus 10 may be any apparatus that processes data including access right information 11c and address book data 12. One example of the image processing apparatus is an apparatus that prints an image on a sheet material such as printing paper. The information processing apparatus capable of forming an image may be referred to as an image forming apparatus, such as a printer, a printing apparatus, or a multifunction peripheral. The multifunction peripheral is an apparatus having multiple functions such as a scanning function, a printing function, a copying function, and a facsimile transmitting/receiving function. The multifunction peripheral may be referred to as a multi-function printer/product/peripheral (MFP), a scan print copy (SPC), or an all in one (AIO).

The PC 40 is one example of an information processing apparatus, and various kinds of applications operate on a general-purpose operating system (OS). The PC 40 is merely a representative of on-premise storages and can be replaced by other on-premise storages. For example, a network attached storage (NAS) on an in-house network, an image processing apparatus (image processing apparatus that is not related to transfer) provided with a large-capacity hard disk drive (HDD) or solid state drive (SSD), or other apparatuses may be used.

The cloud 50 is a resource on a network that is not recognized as a specific hardware resource. In reality, the cloud 50 is an information processing apparatus, a NAS, or the like, at a data center connected via the Internet. Additionally, an information processing apparatus on the Internet may be referred to as a server.

In addition to the PC 40 and the cloud 50, as a storage apparatus, there may be a USB memory, an SD memory card (registered trademark), an optical storage medium such as a CD, DVD, or Blu-Ray, or a removable HDD or SDD. That is, any storage apparatus that has enough capacity for storing document data 11 and address book data 12 stored in the transfer-source image processing apparatus 10A can be used.

In the example of FIG. 3, the address book data 12 and the document data 11 are transferred by Route I or Route II as described below.

Route I: transfer-source image processing apparatus 10A→(export)→PC 40→(import)→transfer-destination image processing apparatus 10B

Route II: transfer-source image processing apparatus 10A→(export)→cloud 50→(import)→transfer-destination image processing apparatus 10B

The Route I has an advantage that the time for transferring data is shorter, compared to Route II. This is because, in a case of communication between an image processing apparatus 10 and the cloud 50, retransmission control tends to occur since there may be too many routers and may be a part in which communication is busy, etc., between the image processing apparatus 10 and the cloud 50.

On the other hand, in a case of Route I, the CE needs to know the IP address and folder path of the PC 40 and set the IP address and folder path of the PC 40 to the transfer-source image processing apparatus 10A. Furthermore, sufficient free space is required in the HDD, etc., of the PC 40. On the other hand, in Route II, the CE needs to log in to the cloud 50, and preparation for the PC 40 is not necessary. Therefore, it is relatively easy to adapt Route II. However, in a case where the size of address book data 12 and document data 11 is large, it takes a long time to transfer.

<Hardware Configuration Example>

<<Hardware Configuration Example of Image Processing Apparatus>>

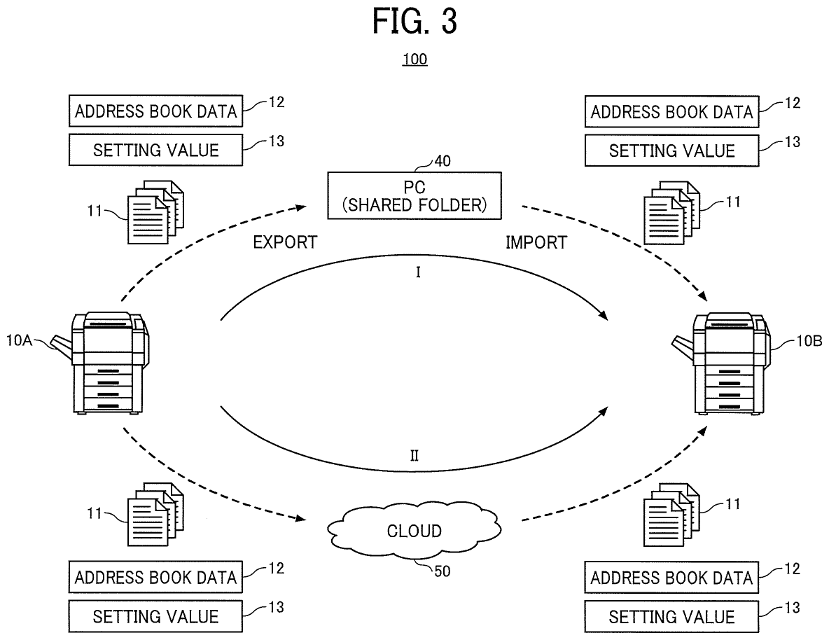

Next, with reference to FIG. 4, an explanation is given of a hardware configuration example of an image processing apparatus 10. FIG. 4 is an example of a hardware configuration diagram of an image processing apparatus 10.

The image processing apparatus 10 includes the CPU 101, the RAM 102, the HDD 103, the plotter I/F 104, the plotter 105, the scanner I/F 106, the scanner 107, the operator I/F 108, the operator 109, the network I/F 110, and the bus 112. As illustrated in FIG. 4, the image processing apparatus 10 has functions of an information processing apparatus.

The CPU 101 executes a program 103p retrieved from the HDD 103 (or a NVRAM, a ROM, etc.) to the RAM 102 and controls the overall operation of the image processing apparatus 10. The program 103p of the HDD 103 is retrieved to the RAM 102 and the RAM 102 is used as a work area in which the CPU 101 reads out an instruction or writes data.

The HDD 103 stores address book data 12, document data 11, and a setting value 13 in addition to a program 103p. The plotter I/F 104 is an interface for the plotter 105. The plotter I/F 104 undertakes control of the plotter 105 from the CPU 101 and performs data conversion, etc. The plotter 105 is an image former that forms an image on printing paper by an electrophotographic method or an inkjet method.

The scanner I/F 106 is an interface for the scanner 107. The scanner I/F 106 undertakes control of the scanner 107 from the CPU 101 and performs data conversion, etc. The scanner 107 generates image data 11a by reading a document on a contact glass by use of an imaging element such as a charge coupled device (CCD) or a complementary metal oxide semiconductor (CIS).

The operator I/F 108 is an interface for the operator 109. The operator I/F 108 controls the operator 109 according to an instruction from the CPU 101 and notifies the CPU 101 of operation contents accepted by the operator 109. The operator 109 includes a hard key, which accepts various kinds of operations from a user. It is often the case that the operator 109 includes a liquid crystal display, on which a setting screen is displayed. Furthermore, in a case where the liquid crystal display includes a tach panel, a soft key is displayed to accept a pressing operation from a user.

The network I/F 110 is a network interface card (NIC), etc., for connecting to a network such as a LAN 111.

<<Hardware Configuration Example of a PC or the Cloud>>

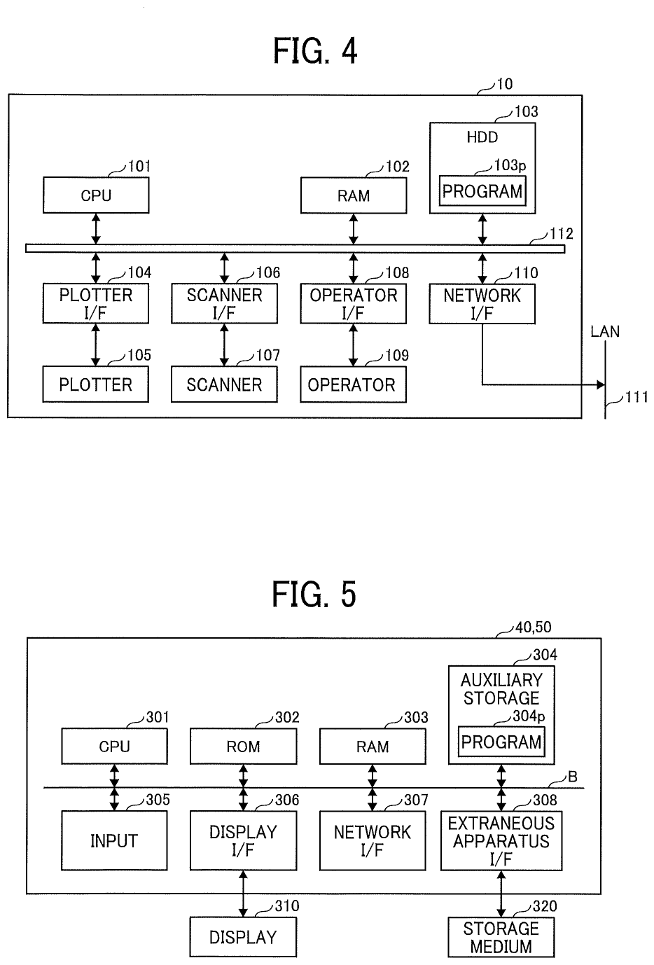

FIG. 5 is an example of a hardware configuration diagram of a PC 40 or the cloud 50. The PC 40 or the cloud 50 includes the CPU 301, the ROM 302, the RAM 303, and the auxiliary storage 304. Furthermore, the PC 40 or the cloud 50 includes the input 305, the display I/F 306, the network I/F 307, and the extraneous apparatus I/F 308. Note that each part of the PC or the cloud 50 is connected to each other via the bus B. As illustrated in the drawing, the PC 40 or the cloud 50 has functions as an information processing apparatus.

The CPU 301 executes various kinds of programs 304p stored in the auxiliary storage 304, an operating system (OS), etc. The ROM 302 is a nonvolatile memory. The ROM 302 stores a system loader, data, and the like.

The RAM 303 is a main storage such as a dynamic random access memory (DRAM) or a static random access memory (SRAM). In a case where a program 304p stored in the auxiliary storage 304 is executed by the CPU 301, the program 304p is retrieved into the RAM 303, and the RAM 303 is used as a work area of the CPU 301.

The auxiliary storage 304 stores a program 304p to be executed by the CPU 301 and various kinds of databases to be utilized in a case where a program 304p is executed by the CPU 301. For example, the auxiliary storage 304 is a nonvolatile memory such as a hard disk drive (HDD) or a solid state drive (SSD).

The input 305 is an interface for an operator to input various kinds of instructions. For example, the input 305 may be a keyboard, a mouse, a touch panel, an audio input apparatus, etc.

The display I/F 306 displays various kinds of information held by the PC 40 or the cloud 50 on the display 310 in such a form as a cursor, a menu, a window, a character, or an image, in response to a request from the CPU 301. For example, the display I/F 306 may be a graphic chip or a display I/F.

The network I/F 307 is a communicator that connects to a network and communicates with an image processing apparatus 10. For example, the network I/F 307 may be, but is not limited to, an Ethernet (registered trademark) card.

The extraneous apparatus I/F 308 is an interface for connecting a USB cable or various kinds of storage media 320 such as a USB memory.

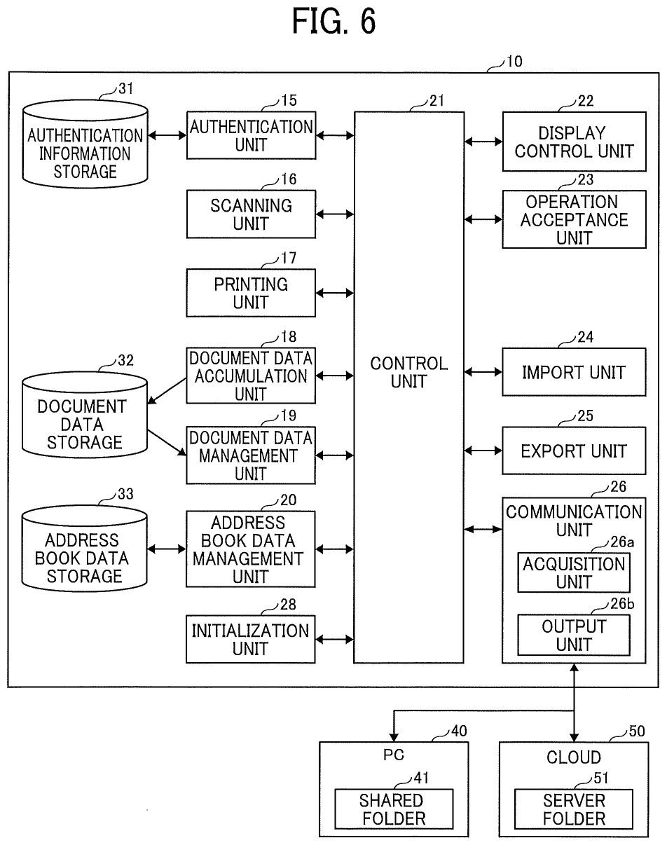

Next, with reference to FIG. 6, an explanation is given of the functions of an image processing apparatus 10. FIG. 6 is a function block diagram illustrating the functions of a transfer-source image processing apparatus 10A and a transfer-destination image processing apparatus 10B in blocks.

The image processing apparatus 10 includes an authentication unit 15, a scanning unit 16, a printing unit 17, a document data accumulation unit 18, a document data management unit 19, an address book data management unit 20, a control unit 21, a display control unit 22, an operation acceptance unit 23, an import unit 24, an export unit 25, a communication unit 26, and an initialization unit 28. Each of the functional units included in the image processing apparatus 10 is a function or means that is realized by operation of one of the components illustrated in FIG. 4 in response to an instruction from the CPU 101 according to a program 103p retrieved from the HDD 103 into the RAM 102.

Note that the same program 103p is installed in the transfer-source image processing apparatus 10A and the transfer-destination image processing apparatus 10B, and the transfer-source image processing apparatus 10A and the transfer-destination image processing apparatus 10B have the same functions in terms of transferring of address book data 12, document data 11, or a setting value 13. Therefore, although one image processing apparatus 10 includes an import unit 24 and an export unit 25 in FIG. 6, the export unit 25 is used by the transfer-source image processing apparatus 10A and the import unit 24 is used by the transfer-destination image processing apparatus 10B.

The authentication unit 15 authenticates a user with reference to the authentication information storage 31. The authentication information storage 31 stores a user name and an authentication password. The authentication unit 15 determines that authentication succeeds in a case where a user name and an authentication password that are input by a user are stored in the authentication information storage 31, and determines that authentication fails in a case where the user name and the authentication password are not stored in the authentication information storage 31. In a case where authentication succeeds, the user is permitted to log in and the entry ID of the user is specified.

Note that an IC card or biometric information may be used for the authentication. A part of the information in the authentication information storage 31 is also held in the address book data storage 33. Alternatively, the address book data storage 33 may be used as the authentication information storage 31 as well.

The scanning unit 16 controls the scanner 107, based on a reading setting that is set by a user, to scan (read) a document and generate image data 11a. The printing unit 17 controls the plotter 105 to print image data 11a on printing paper.

The document data accumulation unit 18 accumulates image data 11a generated by the scanning unit 16 in the document data storage 32. That is, the document data accumulation unit 18 acquires an entry ID from the address book data management unit 20 and accumulates image data 11a, to which bibliographic information 11b and access right information 11c are added, in the document data storage 32. Furthermore, the document data accumulation unit 18 accumulates document data at the time of transferring document data as well.

The document data management unit 19 manages document data 11 in the document data storage 32 and performs access control according to access right information 11c to document data 11 accumulated in the document data storage 32.

The address book data management unit 20 manages address book data 12 in the address book data storage 33. Further, the address book data management unit 20 assigns an entry ID to each user and saves an authentication password, etc., as a part of the address book data 12. Moreover, the address book data management unit 20 reads out the address book data 12 accumulated in the address book data storage 33.

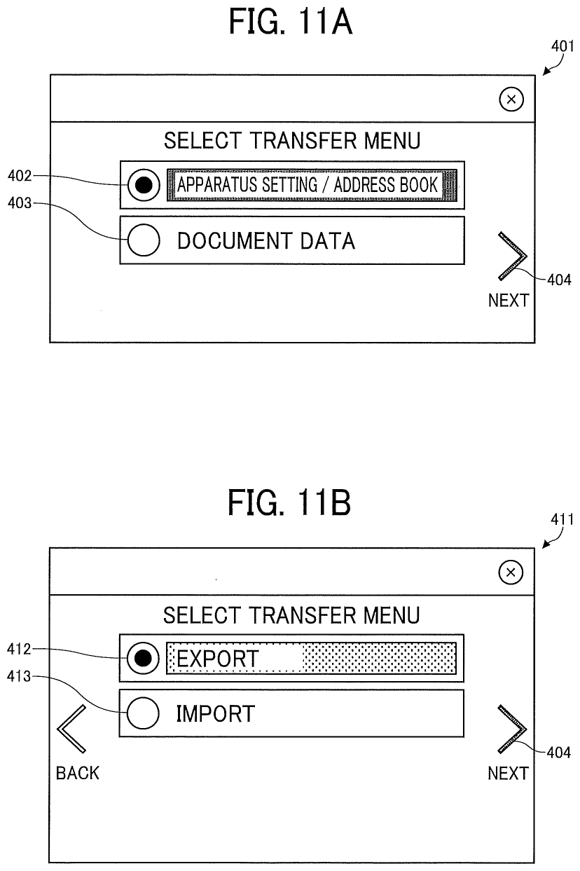

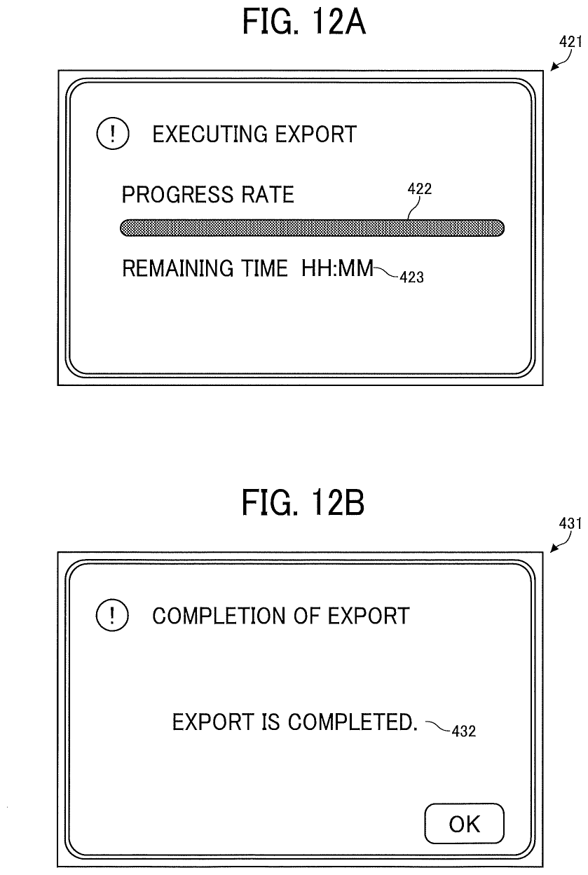

The display control unit 22 displays a scan setting screen, a print setting screen, a facsimile transmission screen, or the like, on the operator 109. Furthermore, a screen (see FIGS. 11A and 11B and FIGS. 12A and 12B) for accepting a setting related to export or import is displayed on the operator 109. The operation acceptance unit 23 accepts a user operation provided to various screens displayed by the display control unit 22 (pressing of a soft key displayed on a touch panel) or accepts pressing of a hard key.

The export unit 25 performs processing related to export of address book data 12, document data 11, or a setting value 13. For example, the export unit 25 acquires document data 11 from the document data management unit 19 or acquires address book data 12 from the address book data management unit 20, to transmit the document data 11 or the address book data 12 to the PC 40 or the cloud 50 via the communication unit 26.

The import unit 24 performs processing related to import of address book data 12, document data 11, or a setting value 13. For example, the import unit 24 acquires address book data 12, document data 11, or a setting value 13 from the PC 40 or the cloud 50, to make the document data accumulation unit 18 accumulate document data 11 or make the address book data management unit 20 store the address book data 12.

The communication unit 26 connects to a network, to perform various kinds of communication with the PC 40 or the cloud 50. That is, the communication unit 26 transmits or receives address book data 12, document data 11, or a setting value 13. For example, in a case of transmission to the PC 40, communication with the PC 40 can be performed by sharing a shared folder with the PC 40 by a communication protocol such as server message block (SMB). In a case of communicating with the cloud 50, communication with the PC 40 or the cloud 50 is performed by use of a communication protocol such as HTTP, HTTPs, or FTP. Note that the communication protocols are merely examples.

The communication unit 26 includes an acquisition unit 26a and an output unit 26b. The acquisition unit 26a acquires address book data 12, document data 11, or a setting value 13 at the time of import, and the output unit 26b outputs address book data 12, document data 11, or a setting value 13 at the time of export. Note that acquiring includes receiving and reading, and outputting includes transmitting and writing.

The control unit 21 controls the overall operation of the image processing apparatus 10. For example, in a case of export, the control unit 21 calls the export unit 25 to make the export unit 25 perform processing related to export. Further, in a case of import, the control unit 21 calls the import unit 24 to make the import unit 24 perform processing related to import.

The initialization unit 28 executes initialization in a case where address book data or document data is registered in the transfer-destination image processing apparatus 10B. In other words, the initialization unit 28 deletes or formats address book data or document data of the transfer-destination image processing apparatus 10B.

Additionally, the PC 40 includes a shared folder 41. The shared folder 41 is a folder that can be accessed from extraneous sources by multiple users and is referred to as the shared folder 41 because a file can be shared by multiple users. Furthermore, the cloud 50 includes a server folder 51, which is a memory area on the cloud. In the shared folder 41 or the server folder 51, address book data 12, document data 11, or a setting value 13 is stored from a timing where export is started to a timing where import is completed.

<Address Book Data>

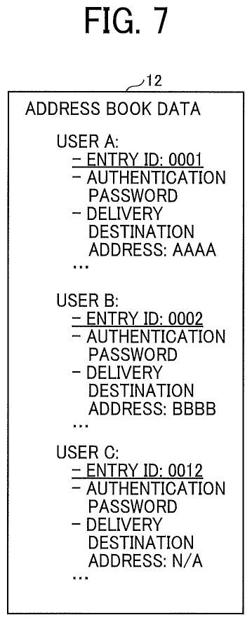

Next, with reference to FIG. 7, an explanation is given of address book data 12. FIG. 7 is a diagram schematically illustrating information included in address book data 12. In the address book data 12, information related to each user who uses the image processing apparatus is registered.

First of all, in the address book data 12, an authentication password of each user, a delivery destination address of document data 11, or the like, is stored as an entry for a user. The authentication password is the same as the one included in the authentication information storage 31, and, in consideration of accessibility, the authentication password is transferred from the authentication information storage 31. Therefore, the information in the address book data 12 may be used for authentication.

Note that an authentication password is confidential information used for authentication of a user, and a delivery destination address of document data 11 is an IP address or email address for transmitting image data 11a, which is generated by scanning, to a user who performed the scanning or a selected user.

For each user in the address book data 12, a unique entry ID is set. An entry ID is internal identification information that uniquely identifies a user in the image processing apparatus 10. For example, an entry ID is a serial number that is assigned by the address book data management unit 20 in the image processing apparatus 10 in order of registration of users. Each time a user is newly registered in the address book data 12, a new entry ID is assigned and saved. In a case where a user is deleted from the address book data 12, the entry ID of the deleted user becomes missing. Since an entry ID is internal identification information, the entry ID for the same user can be different in different image processing apparatuses 10. However, entry IDs are not changed by transfer of the address book data 12.

Note that address book data 12 may include various kinds of information other than the information illustrated in FIG. 7. For example, a user name, a department of a user, a user type, a gender, an age, etc., may be included. A user name is unique identification information of a user. The department of a user is the group, team, or location to which a user belongs. A user type is an attribute representing the role of a user in a company, such as a system administrator, a general user, a document administrator, or a setting administrator. A system administrator is an administrator of the data transfer system. A document administrator is an administrator who has every authority regarding document data 11. A setting administrator is an administrator who has every authority regarding setting values. The administrators may be the same person in the actual operation.

<Access Right Information>

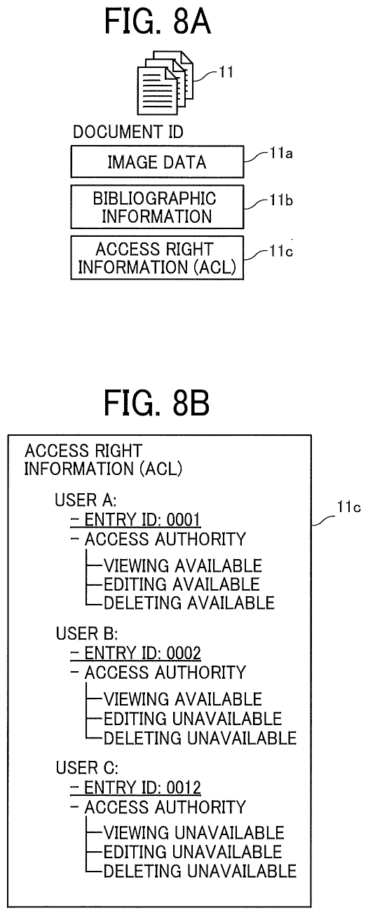

Next, with reference to FIGS. 8A and 8B, an explanation is given of document data 11 and access right information 11c. FIG. 8A is an example of a diagram illustrating information included in document data 11, and FIG. 8B is a diagram schematically illustrating access right information 11c.

As illustrated in FIG. 8A, the document data 11 includes image data 11a, bibliographic information 11b, and access right information 11c. As described below, since access right information 11c is not added to document data 11 registered by a guest user, there is document data that does not include access right information 11c as well. Image data 11a is image data in a predetermined format such as JPEG. Bibliographic information 11b is a setting for reading that is set by a user, an image size, the number of colors, a user name, etc.

Furthermore, a document ID that is unique in the image processing apparatus 10 is assigned to one document data 11. A document ID can be changed when transferred. Note that an ID is abbreviation for Identification, which means that an ID is an identifier or identification information. An ID may be a name, a reference sign, a character string, a numeric number, or a combination of at least one of them to be used for uniquely differentiating a specific target. The same applies to an entry ID.

As illustrated in FIG. 8B, access right information 11c includes an entry ID and an access authority for each user. The number of entries (number of users) in access right information 11c is equal to or lower than the number of entries in address book data 12. The maximum number of entries in access right information 11c can be set, but the number of entries in access right information 11c is basically the same as the number of entries in address book data 12. Therefore, in a case where 100 users are registered in address book data 12, access authorities for 100 users are registered in the access right information 11c of one document data 11. Since an entry ID of access right information 11c is simply copied (duplicated) from address book data 12, the same entry IDs as in the address book data 12 are set in the access right information 11c.

For example, an access authority relates to viewing, editing, and deleting.

Viewing: authority to view a list of document data 11 (contents cannot be viewed)
Editing: authority to edit a file name, etc., of document data 11
Deleting: authority to delete a file in document data 11 “AVAILABLE” or “UNAVAILABLE” is set for each access authority. In addition, an authority for printing, an authority for transmitting, or the like, may be registered.

An explanation is given of how access right information 11c is determined when document data 11 is registered. An access authority is determined mainly based on a user type. The user types to be considered are as follows.

(i) User who is the owner of document data 11

(ii) Specific type of user

(iii) Other users

(i) A user who has logged in to the image processing apparatus 10, that is, a user who has generated document data 11 by reading a document in a case of scanning, is the owner of the document data 11. Similarly, a user who prints a file that is generated by application software is the owner as well. In a case where a user is an owner of document data 11 as such, “VIEWING AVAILABLE”, “EDITING AVAILABLE”, and “DELETING AVAILABLE” are set as an access authority corresponding to the entry ID of the user, for example. This is because the owner should be allowed for such access rights.

(ii) In a case of a specific type of user, an access authority is set according to the user type. For example, a document administrator may need an access authority for editing or deleting. Therefore, for a user who is registered in the address book data 12 with a specific user type, an access authority that is predetermined according to the user type is set.

(iii) For other users, a default access authority is set. For example, “VIEWING AVAILABLE”, “EDITING UNAVAILABLE”, and “DELETING UNAVAILABLE” are set. That is, viewing of a file name is possible, but editing or deleting of a file name of document data 11 is not possible.

<Processing for Accumulating and Utilizing Document Data>

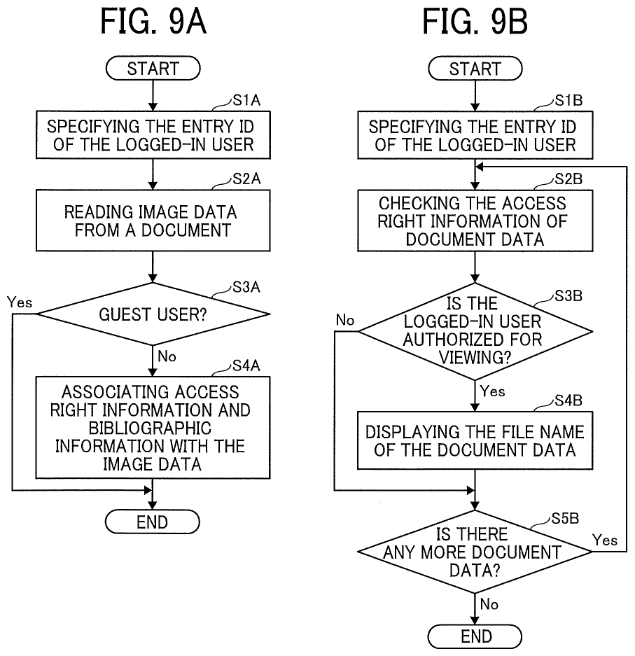

Next, with reference to FIGS. 9A and 9B, an explanation is given of the processing for accumulating document data 11 in an image processing apparatus 10 and the processing for utilizing document data 11. FIG. 9A is an example of a flowchart for explaining the processing for accumulating document data 11 including image data 11a generated by a scanner.

S1A: When a user scans a document, the authentication unit 15 of the image processing apparatus 10 authenticates the logged-in user by use of the authentication password and the user name. In a case where the authentication succeeds, the entry ID of the address book data 12 is specified.

S2A: In a case where the operation acceptance unit 23 accepts a start of reading a document, the scanning unit 16 transmits an instruction for scanning the document to the scanner I/F 106 with a setting for scanning, which is accepted by the operation acceptance unit 23. The image data 11a generated by scanning by the scanner 107 is saved in the RAM 102 via the scanner I/F 106. Then, the image data 11a is converted into a data format for accumulating, as needed, and is accumulated in the document data storage 32.

S3A: The document data accumulation unit 18 determines whether the user is a guest user or not. A guest user is a user who uses the image processing apparatus 10 without authentication. For example, it is possible to enable a user who is on a business trip from another branch of a company or a visitor, etc., to use the image processing apparatus 10. In a case where the user is specified to be a guest user, an authority for a guest is set and access right information 11c is not set. In this case, the image data 11a is accumulated as a document that can be used by a guest user.

S4A: In a case where the user is not a guest user, the document data accumulation unit 18 adds access right information 11c indicating the correspondence with the address book data 12 to the image data 11a. As described in FIGS. 8A and 8B, an access authority corresponding to the user type of a user is set in association with the entry ID (by copying the entry ID) of each user in the address book data 12. Furthermore, bibliographic information 11b such as a setting for reading that is set by a user, an image size, the number of colors, and a user name is added to the image data 11a as well. Image data 11a, bibliographic information 11b, and access right information 11c configure one document data 11.

Note that, although accumulating of document data 11 by use of a scanner is described in FIG. 9A, the same applies to a case of printing a file that is generated by application software such as word processing software.

FIG. 9B is an example of a flowchart for explaining the processing for utilizing accumulated document data 11.

SIB: In a case of printing accumulated document data 11, the entry ID in the address book data 12 is specified by success of authentication for the logged-in user.

S2B: The document data management unit 19 collectively retrieves the document data 11 from the document data storage 32 into the RAM and checks the access right information 11c for the document data 11 on the RAM.

S3B: The document data management unit 19 determines whether the logged-in user is authorized for viewing document data 11, based on the entry ID of the logged-in user, for each document data 11.

S4B: In a case where the logged-in user is authorized for viewing, the document data management unit 19 transmits the file name, etc., of the document data 11 to the display control unit 22, so that the document data 11 is displayed by the display control unit 22 on the operator 109.

S5B: In a case where the next document data 11 exists, the processing returns to S2B. In a case where the next document data 11 does not exist, the processing of FIG. 9B is ended.

The user selects a document to be printed from the displayed list of document data 11 and executes printing. In the same manner as above, the document data management unit 19 determines whether the user is authorized for printing the selected document data 11, based on the entry ID of the user, with reference to the access right information 11c. In a case where the user is authorized, the document data management unit 19 transmits the document data 11 to the printing unit 17. The printing unit 17 makes the plotter 105 to print the image data 11a of the document data 11.

As described above, unless the correspondence between access right information 11c and an entry ID in address book data 12 is correctly saved, it is not possible for each user to print document data 11 even though the document data 11 can be displayed on the operator 109.

<Correspondence between Access Right Information and Entry ID in Address Book Data>

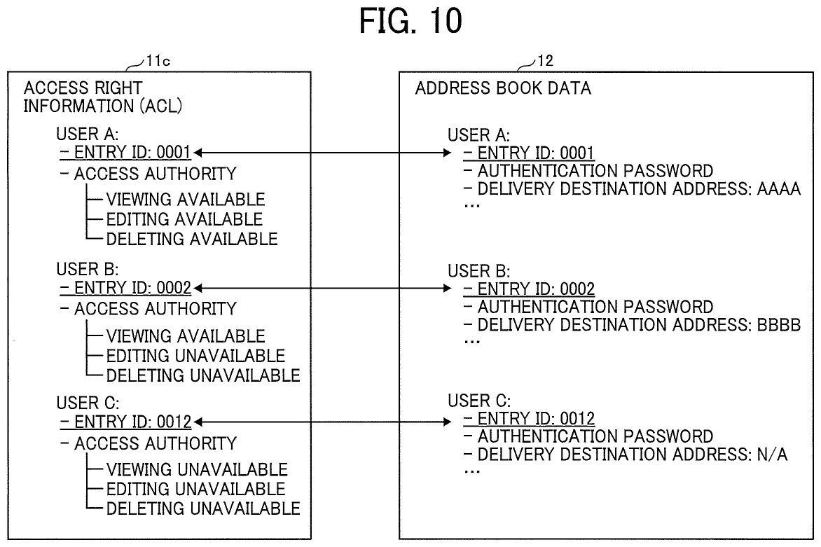

Next, with reference to FIG. 10, an explanation is given of correspondence between an entry ID in access right information 11c and an entry ID in address book data 12. FIG. 10 is a diagram illustrating an example of correspondence between an entry ID in access right information 11c and an entry ID in address book data 12.

As described in FIGS. 8A and 8B and FIGS. 9A and 9B, each of address book data 12 and access right information 11c includes an entry ID. Since the entry ID of each user in address book data 12 is copied to access right information 11c at the time of accumulating document data 11, an association between the access right information 11c and the address book data 12 is established at the timing of accumulating a document. After document data 11 is accumulated, the image processing apparatus 10 controls whether a user can access the document data 11, based on the access right information 11c.

Therefore, as described above, in a case where only document data 11 is transferred at the time of transferring document data 11, there may be a situation in which access control cannot be reproduced in the transfer-destination image processing apparatus 10B.

<Screens Displayed by an Image Processing Apparatus>

Next, with reference to FIGS. 11A and 11B, description is given of examples of a screen displayed on the operator 109 by an image processing apparatus 10. FIG. 11A is an example of a transferred data selection screen 401, and FIG. 11B is an example of a function selection screen 411. The transferred data selection screen 401 is a screen for accepting selection of data to be transferred. The transferred data selection screen 401 includes a radio button 402 associated with the button name “APPARATUS SETTING/ADDRESS BOOK” and a radio button 403 associated with the button name “DOCUMENT DATA”. The radio button 402 associated with “APPARATUS SETTING/ADDRESS BOOK” is for accepting to transfer a setting value 13 and address book data 12. The radio button 403 associated with “DOCUMENT DATA” is for accepting to transfer document data 11.

In a case where the user presses the “NEXT” button 404, the display control unit 22 displays the function selection screen 411 of FIG. 11B on the operator 109. The function selection screen 411 is a screen for accepting to export or to import. The function selection screen 411 includes a radio button 412 associated with the button name “EXPORT” and a radio button 413 associated with the button name “IMPORT”. The radio button 412 associated with “EXPORT” is for accepting to export. The radio button 413 associated with “IMPORT” is for accepting to import.

FIG. 11A illustrates a user interface for separately exporting or importing either one of a setting value 13 and address book data 12 and document data 11. However, there may be a user interface for separately exporting or importing a setting value 13 or address book data 12. Furthermore, there may be a user interface for accepting an instruction for both of address book data 12 and document data 11.

FIG. 12A is a diagram illustrating an example of an export executing screen 421, and FIG. 12B is a diagram illustrating an example of an export completion screen 431. The export executing screen 421 is a screen displayed during the time of exporting, on which the progress bar 422 and the remaining time 423 are displayed. On the export completion screen 431, the message 432 mentioning “EXPORT IS COMPLETED.” is displayed. Screens for importing are overall the same as the screens for exporting.

<Export and Import of Address Book Data>

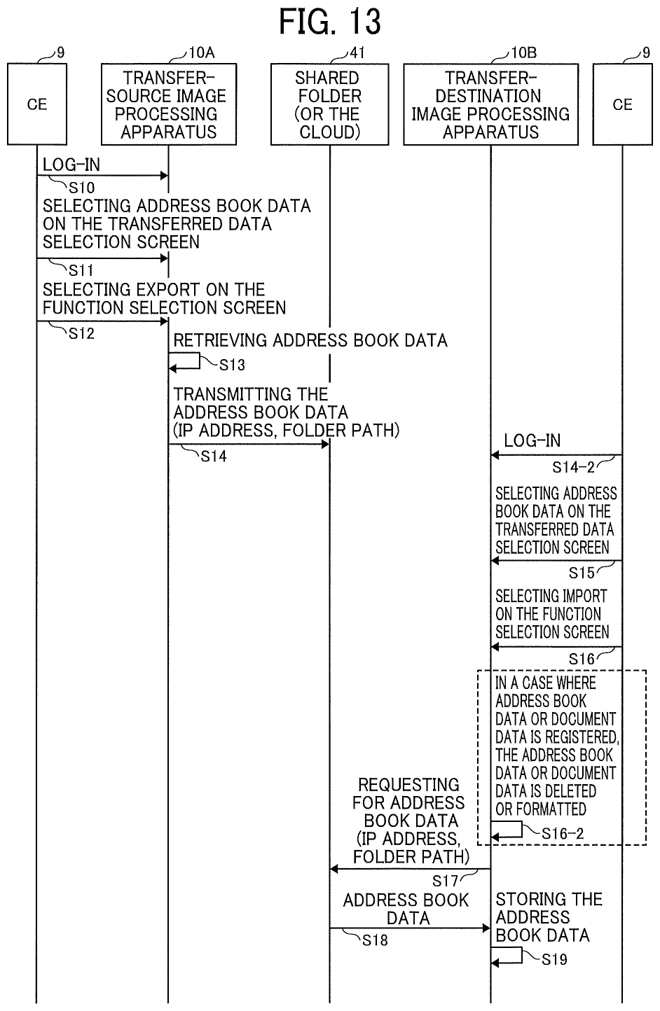

First, with reference to FIG. 13, an explanation is given of the procedure for exporting and importing address book data 12. FIG. 13 is an example of a sequence diagram illustrating the procedure in which a transfer-source image processing apparatus 10A exports address book data 12 to a PC 40 and a transfer-destination image processing apparatus 10B imports address book data 12 from the PC 40.

Note that as a premise of the embodiments of the present invention, it is assumed that a new apparatus in which neither address book data 12 nor document data is registered is prepared as a transfer-destination image processing apparatus 10B (in a case where address book data 12 or document data is registered, initialization is performed on the transfer-destination image processing apparatus 10B. That is, the address book data 12 and the document data of the transfer-destination image processing apparatus 10B are deleted or formatted). The deleting or formatting process may be executed after S10.

S10: The CE 9 logs in to the transfer-source image processing apparatus 10A.

S11: The CE 9 selects the address book data 12 on the transferred data selection screen 401. The operation acceptance unit 23 of the transfer-source image processing apparatus 10A accepts selection of the address book data 12.

S12: The CE 9 selects export on the function selection screen 411. The operation acceptance unit 23 of the transfer-source image processing apparatus 10A accepts to export. Note that the CE 9 sets the IP address and folder path of the shared folder 41 of the PC 40. A desired shared folder 41 may be selected from a list of shared folders 41.

In a case of the cloud 50, since the server folder 51 is managed by the cloud 50, the CE 9 sets a user name and a password for being authenticated by the cloud 50. The URL of the cloud 50 is preliminarily stored in the transfer-source image processing apparatus 10A (more specifically, the program 103p).

S13: Since the control unit 21 of the transfer-source image processing apparatus 10A makes the export unit 25 to start exporting, the export unit 25 requests the address book data management unit 20 for address book data 12. The address book data management unit 20 retrieves the address book data 12 from the address book data storage 33. For example, one user is stored in one folder in order based on entry IDs. It is also possible that all users are compressed in one file. It is preferable that the extension of a file name in the folder is preliminarily determined so that address book data 12 is identifiable. Furthermore, it is also possible that the model name of the transfer-source image processing apparatus 10A or the date and time of export is included in the file name.

S14: The export unit 25 makes the output unit 26b transmit the address book data 12 to the shared folder 41 of the PC 40 with designation of the IP address and folder path. Since address book data is transmitted for each user at the time of transmission, S13 and S14 are repeatedly executed.

Through the above steps, the address book data 12 is transmitted to the shared folder 41 of the PC 40. Setting values are exported as well. Subsequently, the CE can import the address book data 12 from the transfer-destination image processing apparatus 10B. However, since it is often the case that installation of two image processing apparatuses 10 at the same time is difficult at the time of updating an image processing apparatus 10, exporting of document data 11 is usually executed next. That being said, as illustrated in FIG. 13, import may be performed after the export.

S14-2: The CE 9 logs in to the transfer-destination image processing apparatus 10B.

S15: In this explanation, it is assumed that the transfer-destination image processing apparatus 10B is installed. The CE 9 selects the address book data 12 on the transferred data selection screen 401. The operation acceptance unit 23 of the transfer-destination image processing apparatus 10B accepts selection of the address book data 12.

S16: The CE 9 selects import on the function selection screen 411. The operation acceptance unit 23 of the transfer-destination image processing apparatus 10B accepts to import. The method for designating the shared folder 41 can be the same as the time of export, and the same folder as the time of export is designated.

S16-2: In a case where address book data 12 or document data is registered, the initialization unit 28 deletes or formats the address book data 12 or document data.

S17: Since the control unit 21 of the transfer-destination image processing apparatus 10B makes the import unit 24 start importing, the import unit 24 makes the acquisition unit 26a request the PC 40 for the address book data 12 with designation of the IP address and folder path.

S18: Accordingly, the acquisition unit 26a of the transfer-destination image processing apparatus 10B acquires address book data 12 having a predetermined extension from the folder designated by the IP address and folder path. At the time of receiving address book data 12, since address book data 12 is received on a per user basis, S17 and S18 are repeatedly executed as well. In a case where there are files having the same extension, the CE 9 may determine the address book data to be imported, with reference to the model name or the time and date of export included in the file name.

S19: The import unit 24 transmits the address book data 12 acquired via the acquisition unit 26a to the address book data management unit 20 and makes the address book data management unit 20 store the address book data 12. The address book data management unit 20 stores the address book data 12 in the address book data storage 33. Note that difference of a data format, or the like, may be modified as needed.

<Export and Import of Document Data>

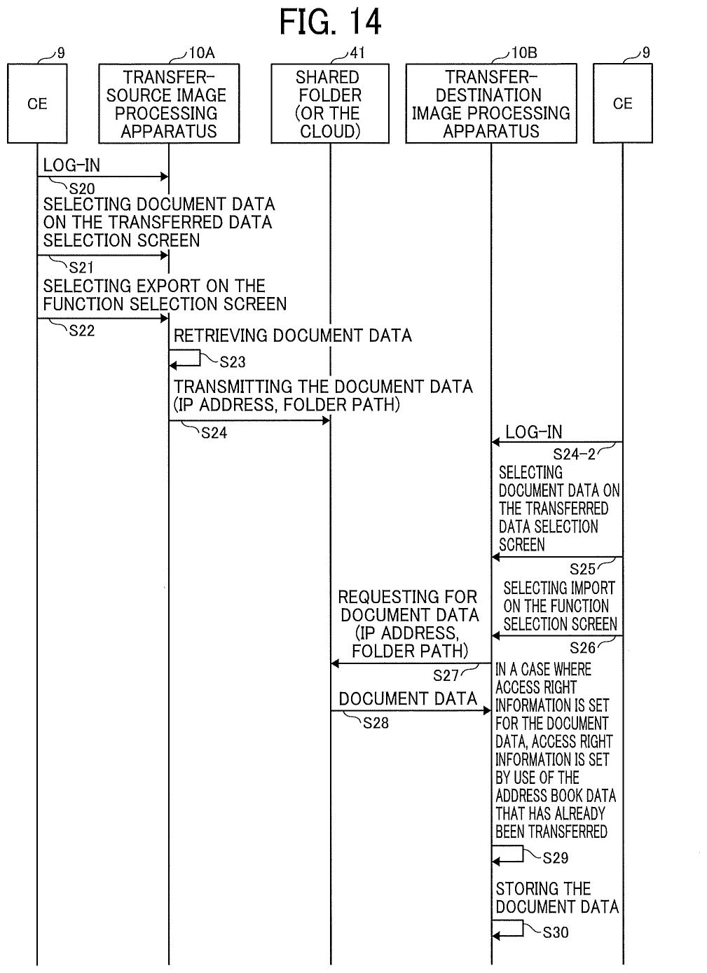

Next, an explanation is given of export and import of the document data 11 with reference to FIGS. 14 through 18.

<<Export>>

FIG. 14 is an example of a sequence diagram illustrating the procedure in which a transfer-source image processing apparatus 10A exports document data 11 to a PC 40 and a transfer-destination image processing apparatus 10B imports document data 11 from the PC 40. The overall procedure of exporting and importing document data 11 is the same as the procedure for the address book data 12 as illustrated in FIG. 13. That is, document data 11 is the target of export and import, instead of the address book data 12.

In a case where access right information has already been set for document data, a process for setting access right information by use of the address book data that has already been transferred is added (S29).

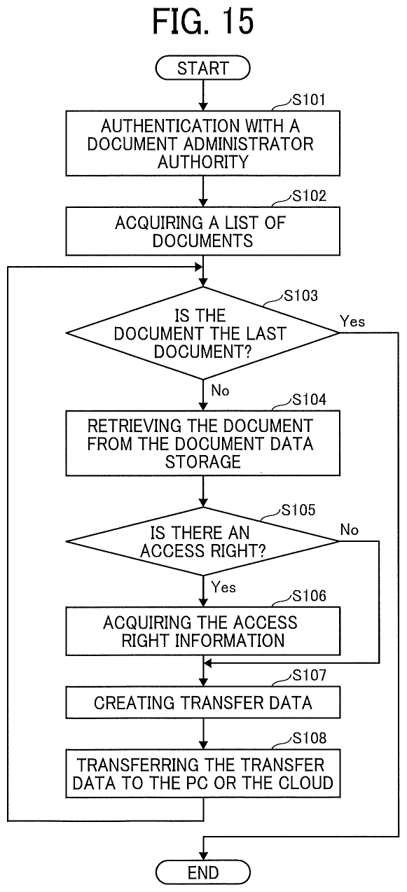

FIG. 15 is an example of a flowchart illustrating the procedure in which a transfer-source image processing apparatus 10A exports document data 11. The processing in FIG. 15 is for explaining details of the processing corresponds to S20, S23, and S24 in FIG. 14.

First, the CE logs in to the transfer-source image processing apparatus 10A by being authorized with a document administrator authority (S101). A document administrator is an administrator who has every authority (except for printing) regarding documents. Since access right information 11c is added to document data 11 accumulated in the document data storage 32, it is necessary to utilize an authority that enables the user to access all the documents in order to extract the document data 11. Although printing of document data 11 is not allowed with the access authority for a document administrator, acquisition of document data 11 is possible only in a case of excepting the document data 11. The authentication unit 15 compares the authentication information that is input by the CE with the authentication information stored in the authentication information storage 31 for allowing the CE to log in as a document administrator.

In a case where the CE logs in as a document administrator, the control unit 21 makes the export unit 25 execute importing with the authority as a document administrator. The export unit 25 makes the document data management unit 19 acquire a list of document data 11 (S102). Since the CE is a document administrator, the CE can view all the document data 11.

In response to acquiring the list of document data 11, the export unit 25 starts exporting each of accumulated document data 11. First, whether the document data 11 is the last one or not is determined (S103). In a case where the determination of S103 results in Yes, the processing of FIG. 15 is ended.

In a case where the determination of S103 results in No, the export unit 25 makes the document data management unit 19 acquire the document data 11. The document data management unit 19 acquires the image data 11a and the bibliographic information 11b from the document data storage 32 (S104).

Next, the document data management unit 19 determines whether access right information 11c is added to the document data 11 (whether an access right is set) or not (S105). For document data 11 accumulated by a guest user, an authority for a guest is set and access right information 11c is not set.

Subsequently, in a case where an access right is set, the import unit 24 acquires the access right information 11c (S106) and stores the image data 11a, the bibliographic information 11b, and the access right information 11c in one folder, to create transfer data (S107).

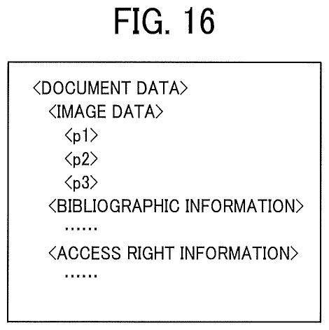

FIG. 16 is an example of transfer data. For example, as illustrated in FIG. 16, folders for the image data 11a, the bibliographic information 11b, and the access right information 11c are further created in one folder, so that each of the image data 11a, the bibliographic information 11b, and the access right information 11c is stored in each of the folders. In a case where the image data 11a includes multiple pages, the image data 11a is stored in the folder with the page order maintained. For example, it is possible to create a folder for each page in the page order. Note that such a format of transfer data as illustrated in FIG. 16 is merely an example. That is, it is possible to collectively store the image data 11a, the bibliographic information 11b, and the access right information 11c in one folder or to compress the image data 11a, the bibliographic information 11b, and the access right information 11c into one file. Returning to FIG. 15, the import unit 24 transmits the transfer data to the shared folder 41 of the PC 40 (S108). The import unit 24 repeats the processing of S103 through S108 for all document data 11.

<<Import>>

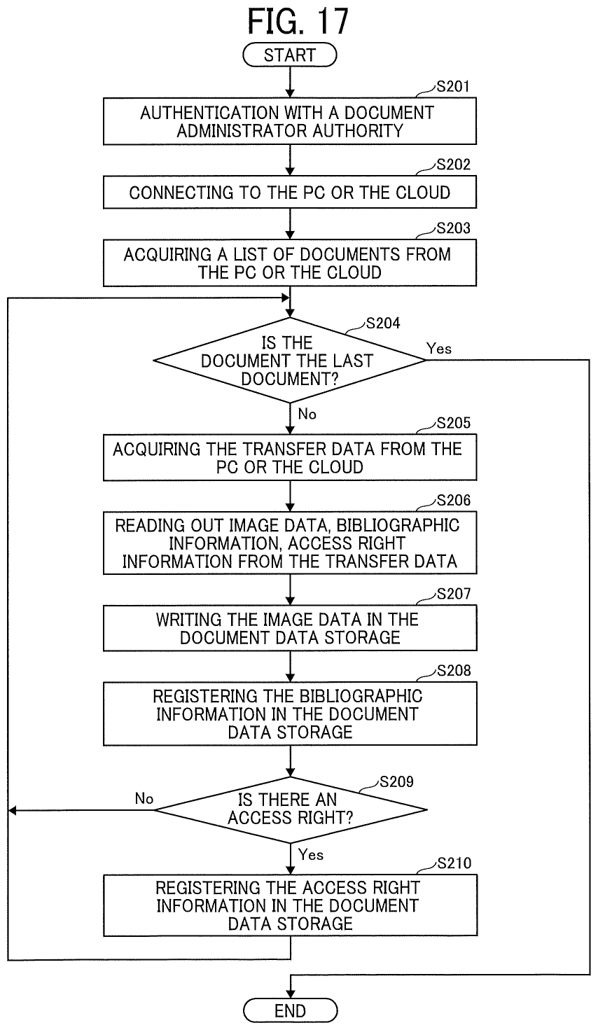

FIG. 17 is an example of a flowchart illustrating the procedure in which a transfer-destination image processing apparatus 10B imports document data 11. The processing in FIG. 17 is for explaining details of the processing corresponds to S24-2 and S27 through S29 in FIG. 14.

The authentication for a document administrator in S201 may be the same as S101 in FIG. 15. This makes it possible for the CE to transfer all document data 11.

Next, the control unit 21 of the transfer-destination image processing apparatus 10B makes the import unit 24 start importing with the authority as a document administrator. The import unit 24 makes the acquisition unit 26a connect to the shared folder 41 indicated by the IP address and folder path set by the CE (S202).

The acquisition unit 26a acquires a list of document data 11 from the shared folder 41 (S203). Upon acquiring the list of document data 11, the import unit 24 starts importing each of accumulated document data 11. First, whether document data 11 is the last one or not is determined (S204). In a case where the determination of S204 results in Yes, the processing of FIG. 17 is ended.

In a case where the determination in S204 results in No, the import unit 24 acquires transfer data one by one via the acquisition unit 26a (S205).

The import unit 24 extracts the image data 11a, bibliographic information 11b, and access right information 11c from the transfer data (S206).

First, the import unit 24 requests the document data accumulation unit 18 for accumulating the image data 11a (S207). Further, the import unit 24 requests the document data accumulation unit 18 for accumulating the bibliographic information 11b (S208).

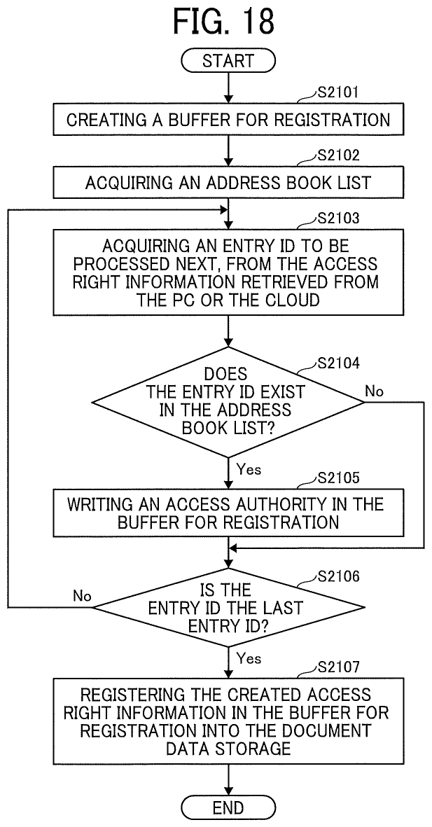

Then, in a case where there is access right information 11c (Yes in S209), the import unit 24 requests the document data accumulation unit 18 for accumulating the access right information 11c (S210). The case in which there is access right information 11c is a case in which access right information has already been set for the document data. Details of the processing of S210 is described with reference to FIG. 18.

FIG. 18 is an example of a flowchart illustrating details of processing of accumulating access right information 11c.

First, the document data accumulation unit 18 prepares a buffer for registration (S2101) as a process for preparing a memory in a predetermined size or more in which access right information is temporarily stored, to collectively register access authority for one document data 11 in the document data storage 32.

Next, the document data accumulation unit 18 acquires a list of address book data 12 from the address book data management unit 20 (S2102), to use entry IDs of the address book data 12.

Next, the document data accumulation unit 18 registers an access authority for each entry ID that is included in access right information 11c acquired from the shared folder 41. Therefore, the document data accumulation unit 18 extracts one entry ID included in the access right information 11c acquired from the shared folder 41 (S2103). Entry IDs may be extracted in ascending order, but may be extracted in descending order or randomly.

Subsequently, whether or not the entry ID acquired in S2103, which is included in the access right information 11c acquired from the shared folder 41, exists in the list of address book data 12 acquired in S2102 is checked and determined (S2104).

In a case where the determination of S2104 results in Yes, the document data accumulation unit 18 sets an access authority (S2105). That is, the document data accumulation unit 18 writes an access authority in the buffer for registration in association with the entry ID that is included in the access right information 11c acquired from the shared folder 41. Thus, transfer can be performed with the correspondence between address book data 12 and document data 11 maintained.

In a case where the determination of S2104 results in No, the document data accumulation unit 18 does not set an access authority. Thus, the user with an entry ID that does not exist in the list of address book data 12 is disabled to access the document data 11. Therefore, it is possible to prevent the security for the document data 11 from being deteriorated due to transfer.

The document data accumulation unit 18 determined whether the entry ID is the last one or not (S2106). In a case where the determination of S2106 results in No, the processing proceeds to S2103.

In a case where the determination of S2106 results in Yes, the access right information 11c for one document data 11 is completed. Therefore, the document data accumulation unit 18 accumulates the access right information 11c, which is stored in the buffer for registration, into the document data storage 32 in association with the image data 11a and the bibliographic information 11b (S2107).

As described above, what are performed in the data transfer system 100 of the present embodiment are as follows.

(i) Deleting or formatting address book data or document data in a transfer destination.
(ii) Transferring address book data first, and then transferring document data.
(iii) In a case where access right information is set for the document data, access right information is set by use of the address book data that has already been transferred. By such processing, in the data transfer system 100 of the present embodiment, it is possible to obtain an effect that address book data 12 and document data 11 can be transferred with the correspondence therebetween maintained. In the data transfer system 100, the transfer-destination image processing apparatus 10B determines whether an entry ID in access right information 11c exists in the entry IDs in address book data 12 or not at the time of transferring document data 11. In a case where the entry ID in the access right information 11c exists in the entry IDs in the address book data 12, an access authority is set for the access right information 11c. Since the document data 11 is transferred based on determination whether the entry ID exists or not, it is possible to transfer the address book data 12 and the document data 11 with the correspondence therebetween maintained in the transfer-destination image processing apparatus 10B and to reproduce the access control in the transfer-destination image processing apparatus 10B. By transferring the address book data 12 first, it is possible to transfer the document data 11 while the address book data 12 from the transfer source exists in the transfer destination.

Note that, for the purpose of transferring an address book and document data 11 with the correspondence therebetween maintained, it is possible for a transfer-destination image processing apparatus 10B to create a conversion table, instead of the method in which an entry ID in access right information 11c is not changed (the entry ID in address book data 12 in a transfer-source image processing apparatus 10A is maintained while transferred). The conversion table is a table for converting an entry ID in the transferred address book data 12 into an entry ID of access right information 11c. By creating such a conversion table, it is possible to change an entry ID in access right information 11c in a transfer-destination image processing apparatus 10B as desired.

### Second Embodiment

In the present embodiment, an explanation is given of a data transfer system 100 in which the data size of access right information 11c can be reduced. Although access right information 11c is transferred in the first embodiment, a default access authority (an access authority for a user who is not an owner nor a user with a specific user type) is set for a major part of the access right information 11c. Since the default access authority is predetermined, it is possible to reproduce the default access authority in a transfer-destination image processing apparatus 10B. For example, an entry ID associated with an access authority that is not the default and the access authority (hereinafter referred to as transfer access right information) are created by a transfer-source image processing apparatus 10A at the time of exporting and transmitted to a shared folder 41 instead of access right information 11c.

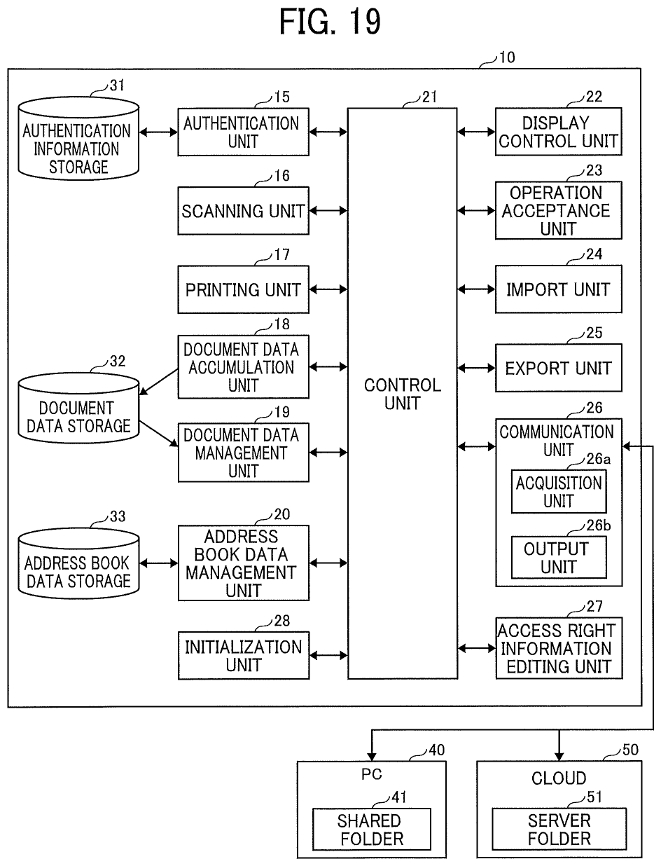

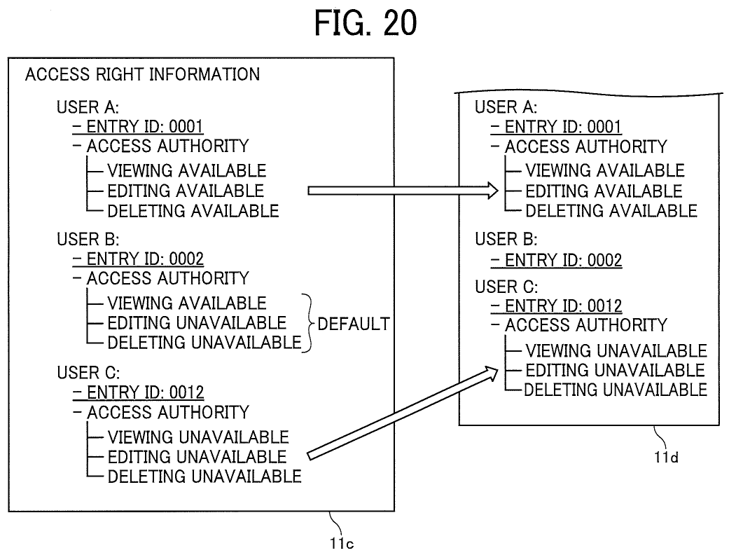

FIG. 19 is an example of a function block diagram illustrating the functions of the transfer-source image processing apparatus 10A and the transfer-destination image processing apparatus 10B in blocks. Note that, with reference to FIG. 19, the difference from FIG. 6 is mainly described. The image processing apparatus 10 of FIG. 19 includes an access right information editing unit 27. The access right information editing unit 27 edits access right information 11c and generates transfer access right information, in which an entry ID associated with an access authority that is not the default and the access authority are registered. FIG. 20 is a diagram for explaining generation of transfer access right information 11d. In the access right information 11c of FIG. 20, it is indicated that the access authority of USER B is “VIEWING AVAILABLE”, “EDITING UNAVAILABLE”, and “DELETING UNAVAILABLE”, which are the default access authority.

The access right information editing unit 27 deletes the access authority while leaving the entry ID of USER B, to generate the transfer access right information 11d. Therefore, it is possible to reduce the data size of the access right information 11c. Since the entry ID remains in the transfer access right information 11d, it is possible for the transfer-destination image processing apparatus 10B to restore the default access right information 11c in association with the entry ID (USER B).

<Export and Import of Document Data>

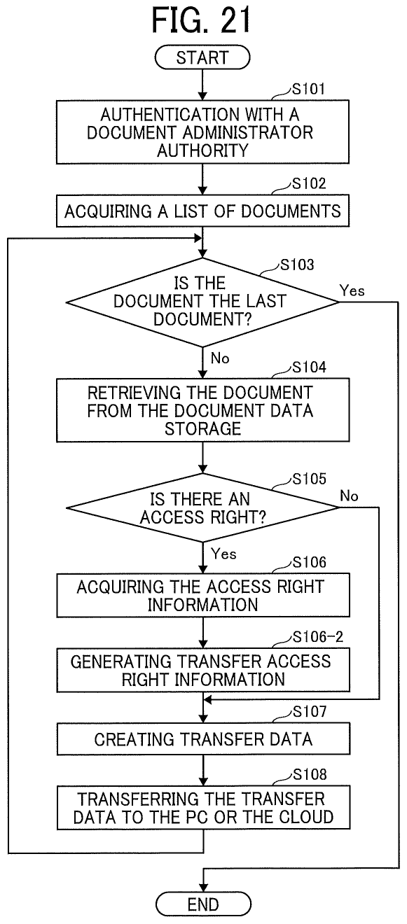

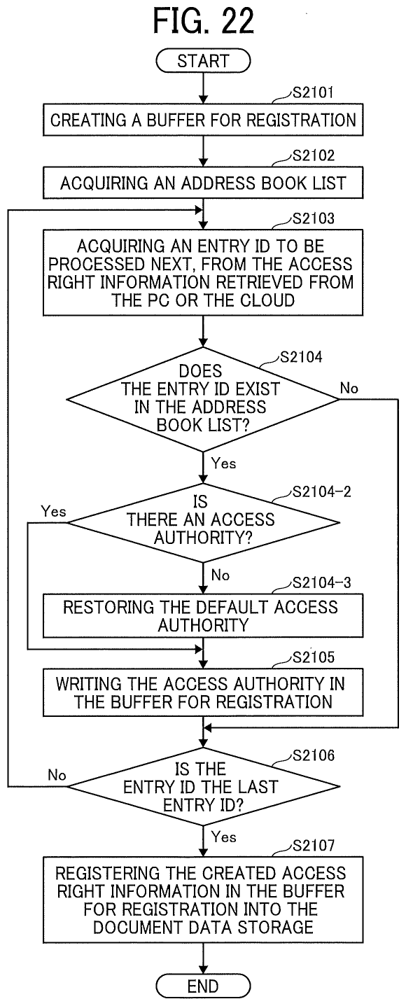

With reference to FIG. 21 and FIG. 22, an explanation is given of export and import of document data 11.

<<Export>>

FIG. 21 is an example of a flowchart illustrating the procedure in which a transfer-source image processing apparatus 10A exports document data 11. In the explanation of FIG. 21, the difference from the FIG. 15 is mainly described. The processing of S101 through S106 may be the same as in FIG. 15.

In S106-2, the access right information editing unit 27 generates the transfer access right information 11d by omitting (deleting) the access authority while leaving the entry ID of USER B (S106-2).

The processing of S107 and S108 may be the same as in FIG. 15.

<<Import>>

FIG. 22 is an example of a flowchart illustrating the procedure in which a transfer-destination image processing apparatus 10B imports document data 11. Note that, in the explanation of FIG. 22, the difference from FIG. 18 is mainly described. The processing of S2101 through S2104 may be the same as in FIG. 18.

In S2104-2, the document data accumulation unit 18 determines whether an access authority is set in the transfer access right information 11d or not (S2104-2).

In a case where an access authority is not set (No in S2104-2), the document data accumulation unit 18 restores the default access authority (S2104-3). That is, the access authority of “VIEWING AVAILABLE”, “EDITING UNAVAILABLE”, and “DELETING UNAVAILABLE” is restored.

After S2104-3 or in a case where an access authority is set (Yes in S2104-2), the document data accumulation unit 18 writes the access authority in association with the entry ID in the buffer for registration, as with the first embodiment (S2105).

The processing of S2106 and S2107 may be the same as in FIG. 18.

Therefore, according to the data transfer system 100 of the present embodiment, in addition to the effect of the first embodiment, the data size of access right information 11c can be reduced, and the communication time with the PC 40 or the cloud 50 at the time of export and import can be reduced.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention.

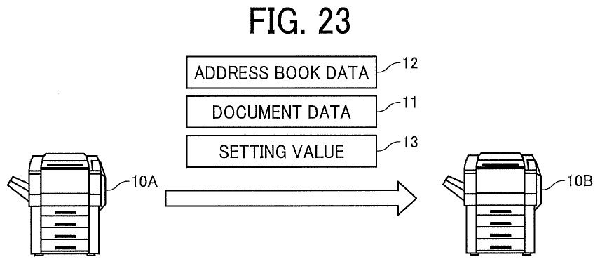

For example, as illustrated in FIG. 23, in a case where the transfer-source image processing apparatus 10A and the transfer-destination image processing apparatus 10B can be turned on a the same time, it is possible to transmit address book data 12, bibliographic information 11b, and document data 11 directly to the transfer-source image processing apparatus 10A and the transfer-destination image processing apparatus 10B. FIG. 23 is a diagram schematically illustrating the direct transfer from the transfer-source image processing apparatus 10A to the transfer-destination image processing apparatus 10B.

In this case, there may be a mode in which the transfer-source image processing apparatus 10A functions as a server, and the transfer-destination image processing apparatus 10B receives the address book data 12, the bibliographic information 11b, and the document data 11 from the server, to perform export or import in the same manner as in the first embodiment or the second embodiment.

Alternatively, the transfer-destination image processing apparatus 10B may be simply used as an extraneous storage apparatus.

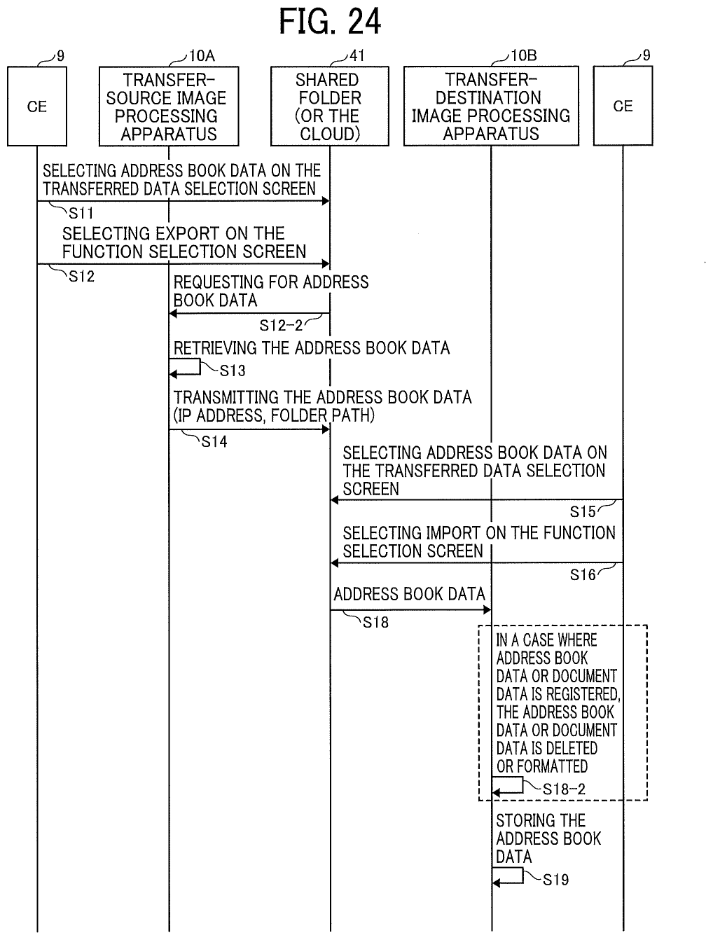

Furthermore, as illustrated in FIG. 24, the CE may operate a PC 40 instead of operating an image processing apparatus 10. FIG. 24 is an example of a sequence diagram illustrating a procedure in which the PC 40 requests the transfer-source image processing apparatus 10A to export address book data and the PC 40 requests the transfer-destination image processing apparatus 10B to import address book data.

In this case, as a Web server, the transfer-source image processing apparatus 10A provides the PC 40 with screen information, which is described in HTML, etc. Browser software is activated on the PC 40 to acquire the screen information and display the screen information on the display 310. The screen may be the same as the transferred data selection screen 401 or the function selection screen 411 as illustrated in FIGS. 11A and 11B. As for the difference from FIG. 13 and FIG. 14, the CE operates the PC 40 to request for address book data in S12-2. Furthermore, S17 is not necessary, and address book data selected by the CE is transmitted (uploaded) to the transfer-destination image processing apparatus 10B in S18.

Therefore, it is possible for the CE to export and import address book data 12, bibliographic information 11b, and document data 11 without physically going to use an image processing apparatus 10.

Furthermore, although an image processing apparatus 10 is taken as an example in the present embodiment, the present embodiment may be applied to an electronic blackboard, a digital signage, a teleconference terminal, or the like. Moreover, a transfer source and a transfer destination may be different kinds of apparatuses.

Furthermore, at least one of the authentication information storage 31, the document data storage 32, and the address book data storage 33 included in an image processing apparatus may be anywhere on a network that is accessible by the image processing apparatus 10, instead of being included in the image processing apparatus 10.

In addition, the configuration examples illustrated in the above embodiments, such as the configuration in FIG. 6, are divided in accordance with the main functions, in order to make it easy to understand the processing of the image processing apparatus 10. However, the present invention is not limited based on how the processing units are divided into or the names of the processing units. The image processing apparatus 10 may be divided into an even larger number of processing units in accordance with processing contents. Furthermore, it is possible to divide the image processing apparatus 10 so that one processing unit includes more processing.

Any one of the above-described operations may be performed in various other ways, for example, in an order different from the one described above.

Each of the functions of the described embodiments may be implemented by one or more processing circuits or circuitry. Processing circuitry includes a programmed processor, as a processor includes circuitry. A processing circuit also includes devices such as an application specific integrated circuit (ASIC), digital signal processor (DSP), field programmable gate array (FPGA), and conventional circuit components arranged to perform the recited functions.

In this disclosure: a transfer-source image processing apparatus 10A is an example of a second information processing apparatus; a transfer-destination image processing apparatus 10B is an example of a first information processing apparatus; address book data is an example of first data; document data is an example of second data; the acquisition unit 26a of the transfer-destination image processing apparatus 10B is an example of an acquisition unit; the initialization unit 28 is an example of an initialization unit; the address book data storage 33 is an example of a first data storage; the document data storage 32 is an example of a second data storage; the document data accumulation unit 18 is an example of a data accumulation unit; and the output unit 26b of the transfer-source image processing apparatus 10A is an example of an output unit.

1. An information processing apparatus for importing data exported from other information processing apparatus, the information processing apparatus comprising:
circuitry; and
one or more memories including a first storage area and a second storage area, the circuitry being configured to
acquire a first data including one or more user registration items each having information registered in relation to a user and being assigned with identification information,
acquire a second data after acquiring the first data, the second data including an access authority that is set for each of one or more user registration items,
store the first data in the first storage area, and
based on a determination that an access authority for the second data is associated with the identification information of the user registration item, set an access authority for the second data using the first data stored in the first storage area for each user registration item, and store the second data that is set in the second storage area.

2. The information processing apparatus according to claim 1, wherein the circuitry is configured to initialize the information processing apparatus before acquiring the first data and the second data, based on a determination that the information processing apparatus previously stores at least one of the first data and the second data.

3. The information processing apparatus according to claim 1, wherein, when the identification information of each user registration item included in the second storage area matches the identification information of each user registration item included in the first data stored in the first storage area, the circuitry stores the second data in which an access authority for the second data is set for each of the user registration items.

4. The information processing apparatus according to claim 3, wherein, when the second data includes at least one user registration item having no predetermined access authority being set, and the at least one user registration item is not associated with access authority, the circuitry restores the predetermined access authority for the at least one user registration item.

5. The information processing apparatus according to claim 4, wherein the predetermined access authority is a default access authority which indicates one of availability for viewing the second data, unavailability for editing the second data, and unavailability for deleting the second data.

6. The information processing apparatus according to claim 3,
wherein the one or more memories further include a buffer that temporarily stores an access authority for each user registration item,
wherein the first data is stored in the first storage area before the second data is stored in the second storage area, and
wherein the circuitry is configured to
determine whether the identification information of each user registration item included in the second data matches the identification information of each user registration item included in the first data,
write the access authority and the identification information of each of the one or more user registration items in the buffer, based on a determination that the identification information of each user registration item included in the second data matches the identification information of each user registration item included in the first data, and
accumulate the identification information and the access authority of each of the one or more user registration items written in the buffer in the second storage area.

7. The information processing apparatus according to claim 1,
wherein the first data includes information related to each user who uses the first information processing apparatus, each user registration item corresponding to each user, and
wherein the second data is data to be a target of printing, the second data including an access authority that is set for the second data, the access authority corresponding to each user who uses the first information processing apparatus.

8. The information processing apparatus according to claim 1,
wherein the first data and the second data are each acquired from an extraneous source, different than the other information processing apparatus.

9. A system for transferring data, comprising:
a first information processing apparatus including first circuitry configured to import data, and one or more memories including a first storage area and a second storage area; and
a second information processing apparatus including second circuitry configured to export data to be imported into the first information processing apparatus,
wherein the second circuitry is configured to output a first data including one or more user registration items each having information registered in relation to a user and being assigned with identification information, and a second data including an access authority that is set for each of one or more user registration items,
wherein the first circuitry is configured to:
acquire the first data,
acquire the second data after acquiring the first data,
store the first data in the first storage area, and
based on a determination that an access authority for the second data is associated with the identification information of the user registration item, set an access authority for the second data using the first data stored in the first storage area for each user registration item, and store the second data that is set in the second storage area.

10. A method for transferring data, from one information processing apparatus to other information processing apparatus, comprising:
acquiring a first data including one or more user registration items each having information registered in relation to a user and being assigned with identification information;
acquiring a second data after acquiring the first data, the second data including an access authority that is set for each of one or more user registration items;
storing the first data in the first storage area, and
based on a determination that an access authority for the second data is associated with the identification information of the user registration item, setting an access authority for the second data using the first data stored in the first storage area for each user registration item, and store the second data that is set in the second storage area.
